(19) United States
(12) Patent Application Publication
(10) Pub. No.: US 2023/0398850 A1
(43) Pub. Date: Dec. 14, 2023

(54) MULTI-CAVITY OBJECT FASTENING ASSEMBLY AND METHOD

(71) Applicant: FORD GLOBAL TECHNOLOGIES, LLC, Dearborn, MI (US)

(72) Inventor: Micah SMITH, Detroit, MI (US)

(21) Appl. No.: 17/838,619

(22) Filed: Jun. 13, 2022

(51) Int. Cl. B60K 1/04; H01M 50/249

(52) U.S. Cl. CPC B60K 1/04; H01M 50/249; B60K 2001/0438; F16B 2001/0092

(57) ABSTRACT

An assembly according to an exemplary aspect of the present disclosure includes, among other things, an object including a cavity. A sleeve is received through a hole formed through the object and extending through the cavity. A fastener is received within the sleeve.

### TECHNICAL FIELD

This disclosure relates to a fastening assembly and method for use with multi-cavity objects.

### BACKGROUND

Inserting a fastener through a multi-cavity object, such as those found inside traction battery packs, can be challenging. A receiving hole for accepting the fastener is typically hidden, and therefore it can be difficult to ensure that the fastener actually engages the receiving hole.

### SUMMARY

An assembly according to an exemplary aspect of the present disclosure includes, among other things, an object including a cavity. A sleeve is received through a hole formed through the object and extending through the cavity. A fastener is received within the sleeve.

In a further non-limiting embodiment of the foregoing assembly, the object includes a divider between a top and a bottom. The cavity is a first cavity positioned between the top and the divider and a second cavity is positioned between the divider and the bottom.

In a further non-limiting embodiment of the foregoing assembly, the hole extends through the top, the divider, and the bottom. The sleeve extends from the top, through the divider and the first and second cavities, to the bottom of the object.

In a further non-limiting embodiment of the foregoing assembly, a top of the sleeve is sub-flush with the top of the object.

In a further non-limiting embodiment of the foregoing assembly, the fastener includes a head that sits on the top of the object, the head including a diameter that is greater than a diameter of the sleeve and a diameter of the hole.

In a further non-limiting embodiment of the foregoing assembly, the fastener includes a shank extending through the sleeve from the top, through the divider and the first and second cavities. A portion of the shank extends past the bottom of the object.

In a further non-limiting embodiment of the foregoing assembly, the object is a first object and further comprising a second object including a receiving hole. The portion of the shank is received in the receiving hole.

In a further non-limiting embodiment of the foregoing assembly, the object is a first object and further comprising a second object including a receiving hole. The fastener is partially received in the receiving hole.

In a further non-limiting embodiment of the foregoing assembly, the first object is disposed between a first row and a second row of battery cells in a battery enclosure of an electrified vehicle. The second object is a floor of a tray of the battery enclosure.

In a further non-limiting embodiment of the foregoing assembly, the first object is disposed adjacent to a second tier row of battery cells in a battery enclosure of an electrified vehicle. The second object is a support structure of a first tier row of battery cells.

In a further non-limiting embodiment of the foregoing assembly, the sleeve includes a lead-in taper such that there is a larger nominal gap between the sleeve and the hole at a bottom of the sleeve than at a top of the sleeve.

A method according to an exemplary aspect of the present disclosure includes, among other things, inserting a sleeve through a hole formed in a first object such that the sleeve extends through a cavity of the object. The hole of the first object is aligned with a receiving hole of a second object. A fastener is inserted into the sleeve to guide the fastener to be partially received in the receiving hole.

In a further non-limiting embodiment of the foregoing method, the first object includes a divider between a top and a bottom. The cavity is a first cavity positioned between the top and the divider and a second cavity is positioned between the divider and the bottom.

In a further non-limiting embodiment of the foregoing methods, a hole is provided through the top, the divider and the bottom prior to the step of inserting the sleeve.

In a further non-limiting embodiment of the foregoing methods, inserting the sleeve includes inserting the sleeve such that it extends from the top, through the divider and the first and second cavities, to the bottom of the first object.

In a further non-limiting embodiment of the foregoing methods, the step of inserting the fastener includes inserting a shank of the fastener such that it extends through the sleeve from the top, through the divider and first and second cavities, and a portion of the shank extends past the bottom of the first object and is received in the receiving hole.

In a further non-limiting embodiment of the foregoing methods, the first object is fastened to the second object by rotating the fastener.

In a further non-limiting embodiment of the foregoing methods, the first object is disposed between a first row and a second row of batteries in a battery enclosure of an electrified vehicle. The second object is a floor of a tray of the battery enclosure.

A traction battery pack according to an exemplary aspect of the present disclosure includes, among other things, a tray including a floor and side walls. A plurality of battery arrays are supported on the tray. An object is positioned adjacent to at least one of the plurality of battery arrays and extends between the side walls. The object includes a cavity. A sleeve is received through a hole formed through the object and extends through the cavity. A fastener is received within the sleeve.

In a further non-limiting embodiment of the foregoing traction battery pack, the floor includes a receiving hole and the fastener is partially received in the receiving hole.

The embodiments, examples, and alternatives of the preceding paragraphs, the claims, or the following description and drawings, including any of their various aspects or respective individual features, may be taken independently or in any combination. Features described in connection with one embodiment are applicable to all embodiments, unless such features are incompatible.

### BRIEF DESCRIPTION OF THE FIGURES

The various features and advantages of the disclosed examples will become apparent to those skilled in the art from the detailed description. The figures that accompany the detailed description can be briefly described as follows:

FIG. 1 is a side view of an electrified vehicle.

FIG. 2 is a perspective view of a battery pack of the electrified vehicle of FIG. 1 with select portions removed in order to better illustrate an interior of the battery pack.

FIG. 3 is a section view of a battery pack of FIG. 2. The battery pack includes a multi-cavity object fastening assembly.

FIG. 4 schematically illustrates a method of fastening a multi-cavity object.

### DETAILED DESCRIPTION

This disclosure details a multi-cavity object fastening assembly and method which may be used in a battery pack of an electrified vehicle. An exemplary assembly includes a hole extending through a multi-cavity object, a sleeve received in the hole, and a fastener received in and guided by the sleeve.

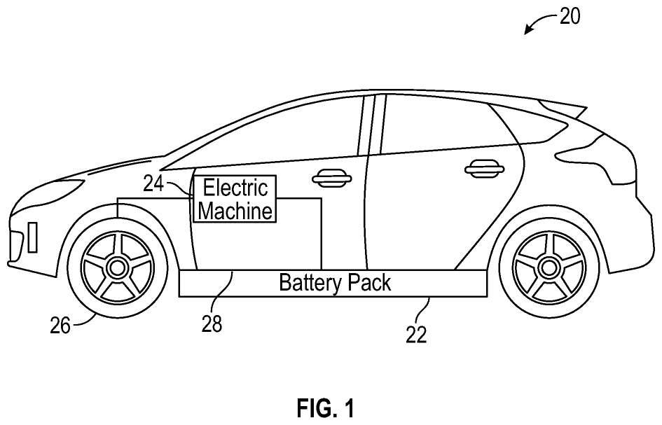

FIG. 1 illustrates an exemplary electrified vehicle 20 that includes a battery pack 22 that powers an electric machine 24 and other electrical loads of the electrified vehicle 20. The electrified vehicle 20 includes wheels 26 driven by the electric machine 24. The electric machine 24 can receive electric power from the battery pack 22 and convert the electric power to torque to drive the wheels 26. The battery pack 22 may be a high-voltage traction battery pack.

The battery pack 22 is secured to an underbody 28 of the electrified vehicle 20, but could be located elsewhere in other examples. The battery pack 22 can be secured to the underbody 28 using, for example, mechanical fasteners.

The electrified vehicle 20 is an all-electric vehicle. In other examples, the electrified vehicle 20 is a hybrid electric vehicle, which selectively drives wheels 26 using torque provided by an internal combustion engine instead of, or in addition to, the electric machine 24.

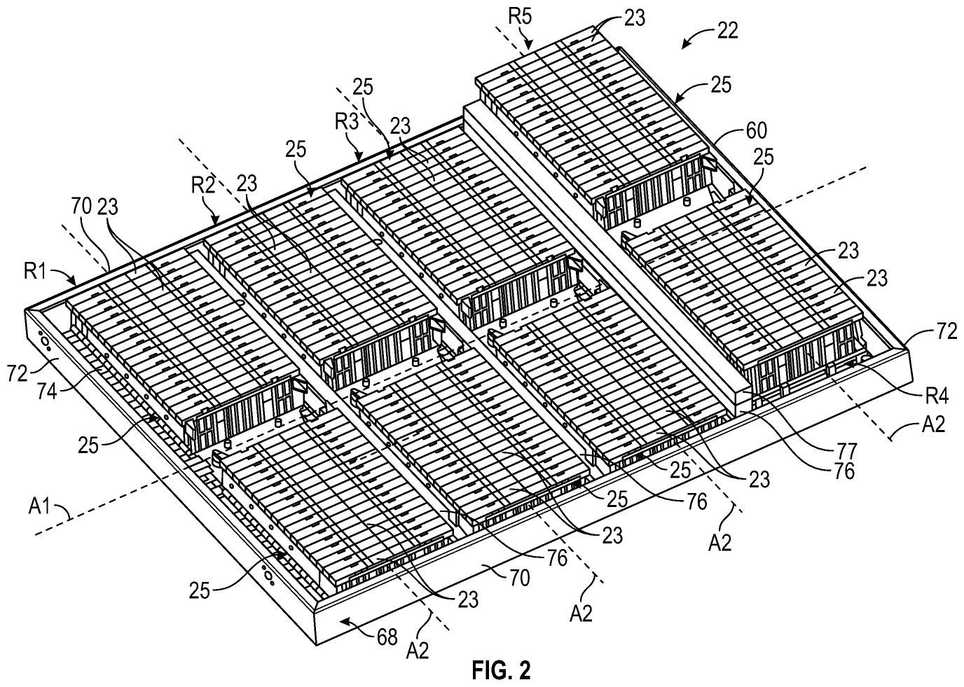

FIG. 2 illustrates a battery pack 22 that can be employed within an electrified vehicle, such as the electrified vehicle 20 of FIG. 1. The battery pack 22 may house a plurality of battery cells 23 that store energy for powering various electrical loads of the electrified vehicle 20. The battery pack 24 could employ any number of battery cells 23 within the scope of this disclosure.

The battery cells 23 may be stacked side-by-side to construct groupings of battery cells 23. The battery cells 23 of each grouping, along with any support structures (e.g., array frames, spacers, rails, walls, end plates, side plates, bindings, etc.), may collectively be referred to as a battery array 25. The battery pack 22 depicted in FIG. 2 includes four rows (labeled as rows R1, R2, R3, and R4) of two laterally adjacent battery arrays 25 for a total of eight battery arrays 25. An additional row R5 (i.e, a second tier) of two adjacent battery arrays 25 may be stacked on top of at least one of the R1-R4 (as illustrated, row R5 is stacked on top of row R4) for a total of ten battery arrays 25. However, the battery pack 22 could include a greater or fewer number of battery arrays and still fall within the scope of this disclosure.

An enclosure assembly 66 may house each battery array 25 of the battery pack 22. The enclosure assembly 66 may extend along a central longitudinal axis A1 and may include a tray 68 and a cover (not shown). The enclosure assembly 66 may include any size, shape, and configuration within the scope of this disclosure. The tray 68 includes a pair of longitudinally extending side walls 70, a pair of laterally extending side walls 72, and a floor 74 disposed between the pair of longitudinally extending side walls 70 and the pair of laterally extending side walls 72. The longitudinally extending side walls 70 may extend in parallel with the central longitudinal axis A1, and the laterally extending side walls 72 may extend generally perpendicular to the central longitudinal axis A1. When mounted to the electrified vehicle 20, the longitudinally extending side walls 70 of the tray 68 extend in parallel with a front-to-rear length of the electrified vehicle 20, and the laterally extending side walls 72 extend in parallel with the cross-width of the electrified vehicle 20.

A battery cross-member 76 may be positioned between each adjacent row of battery arrays 25. In general, the cross-members 76 add rigidity to the battery pack 22 and may establish mounting points for securing the battery arrays 25 relative to the tray 68.

In an example, one cross-member 76 is disposed between the rows R1 and R2 of battery arrays 25, another cross-member 76 is disposed between the rows R2 and R3, and yet another cross-member 76 is disposed between the rows R3 and R4 for a total of three cross-members 76 provided within the enclosure assembly 66. However, the total number of cross-members 76 provided inside the enclosure assembly 66 is not intended to limit this disclosure. In an example, a second tier cross-member 77 is disposed above the cross-member 76 that is between rows R3 and R4, such that the second tier cross-member 77 is adjacent to the second tier row R5.

The cross-members 76 may connect between the longitudinally extending side walls 70 of the tray 68 and therefore are arranged, in the illustrated example, in a cross-vehicle orientation. In an example, both the battery arrays 25 and the cross-members 76 extend along axes A2 that are generally perpendicular to the central longitudinal axis A1 of the enclosure assembly 66.

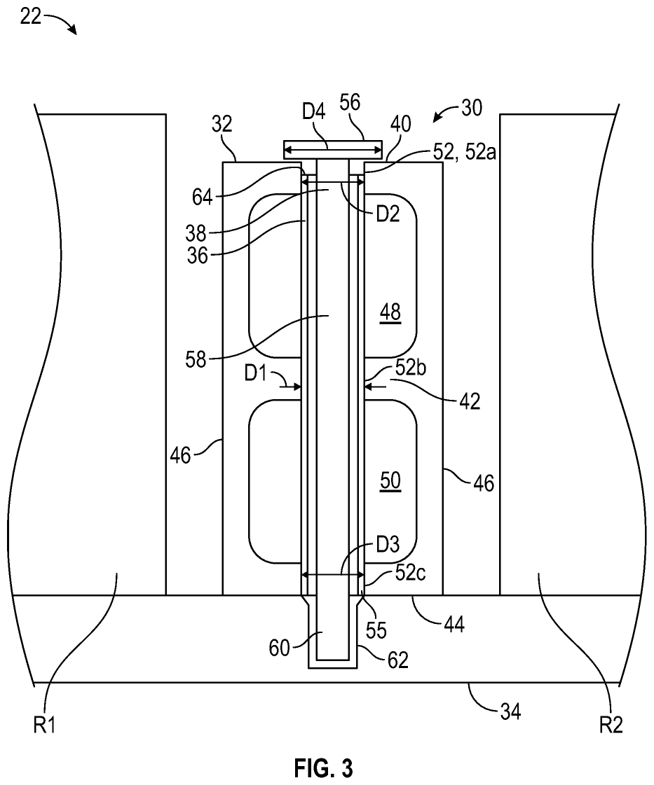

FIG. 3 illustrates an exemplary multi-cavity object fastening assembly 30 within the battery pack 22. The assembly 30 includes a multi-cavity object 32, a second object 34, a sleeve 36, and a fastener 38. In an example, the multi-cavity object 32 is a cross-member 76 positioned between the first row R1 and the second row R2 of battery arrays 25 in the battery pack 22 and the second object 34 is the floor 74 of the tray 68 of the battery enclosure 66. In another example, the multi-cavity object 32 is a second tier cross-member 77 positioned adjacent to a second tier row R5 of battery arrays 25 and the second object 34 is cross-member 76 or other support structure of a first tier row R3, R4 of battery arrays 25.

In an example, the multi-cavity object 32 includes a top 40, a divider 42, a bottom 44, and sides 46. The divider 42 separates a first cavity 48 defined between the top 40 and the divider 42 from a second cavity 50 defined between the bottom 44 and the divider 42. In an example, the cavities 48, 50 extend the entire length of the multi-cavity object 32. Including the cavities 48, 50 and the divider 42 reduces the weight of the multi-cavity object 32 while maintaining stiffness. A hole 52 extends through the top 40, the divider 42, and the bottom 44 of the multi-cavity object 32. That is, the top 40 includes a hole 52a, the divider 42 includes a hole 52b, and the bottom 44 includes a hole 52c, with the holes 52a, 52b, 52c all aligned and including the same diameter D1.

The sleeve 36 is received within the hole 52 and may be configured as a hollow, thin-walled cylinder. In an example, the sleeve 36 is made of a plastic with resistance to flammability, such as nylon, polyethylene, polyester, polyvinyl chloride (PVC), etc. In other examples, the sleeve may be made of metal. In an example, the sleeve 36 extends from the top 40, through the divider 42 and cavities 48, 50 to the bottom 44 of the multi-cavity object 32. In an example, a bottom 55 of the sleeve 36 is aligned directly over a receiving hole 62 in the second object 34.

In an example, the sleeve 36 forms a press or interference fit within a diameter D1 of the hole 52. The sleeve 36 may include a lead-in taper defined by a top diameter D2 at a top 64 of the sleeve 36 being slightly greater than a bottom diameter D3 at the bottom 55 of the sleeve 36. In an example, due to the lead-in taper, there is a larger nominal gap between the sleeve 36 and the hole 52 at the bottom of the sleeve than at the top. In an example, a nominal gap between the diameter D1 of the hole 52 and the top diameter D2 of the sleeve 36 may be about 0.15 mm and a nominal gap between the diameter D1 of the hole 52 and the bottom diameter D3 of the sleeve 36 is about 0.5 mm. In examples, the sleeve 36 may include a 1 mm chamfer at the top 64. The lead-in taper and/or chamfer may facilitate inserting the sleeve 36 into the hole 52.

In an example, the fastener 38 includes a head 56 and a shank 58. The head 56 sits on the top 40 of the multi-cavity object 32. The shank 58 extends through the sleeve 36 from the top through the divider 42 and cavities 48, 50, to the bottom 44 of the multi-cavity object 32. The shank 58 may include a portion 60 extending past the bottom 44 of the multi-cavity object 32 and bottom 55 of the sleeve 36.

The portion 60 of the shank 58 may be received in the receiving hole 62. In an example, the portion 60 of the shank and the receiving hole 62 are both threaded, such that the portion 60 is threadably received within the receiving hole 62. The fastener 38 may engage the receiving hole 62 to fasten the multi-cavity object 32 to the second object 34.

In examples, the sleeve 36 is not be configured to be load bearing. Accordingly, the head 56 of the fastener 38 may include a diameter D4 which is larger than the diameter D1 of the hole. In this manner, the tensioning force provided by the fastener 38 may be applied to the top 40 of the multi-cavity object 32 and not solely to the sleeve 36. The top 64 of the sleeve 36 may also be positioned sub-flush with, or just below, the top 40 of the multi-cavity object 32. Thus, the head 56 may not contact the sleeve 36, and no tensioning load need be supported by the sleeve 36.

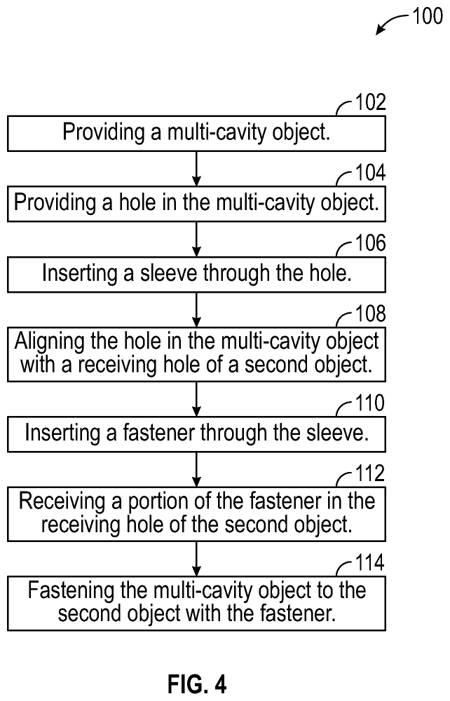

FIG. 4 illustrates an exemplary method 100 of fastening the fastening assembly 30. At step 102, the multi-cavity object 32 is provided. The multi-cavity object 32 may be provided as a pre-fabricated component or may be provided by fabrication, for example by extrusion. At step 104, a hole 52 is provided through the top 40, the divider 42, and the bottom 44 of the multi-cavity object. The hole 52 may be provided by drilling through the multi-cavity object 32, for example.

At step 106, the sleeve 36 is inserted through the hole 52. The sleeve 36 may be pressed into the hole 52 by a machine press. At step 108, the hole 52 of the multi-cavity object 32 is aligned with the receiving hole 62 of the second object 34. At step 110 the fastener 38 is inserted into the sleeve 36 such that it is guided by the sleeve 36 from the top 40, through divider 42 and cavities 48, 50, and a portion 60 of the shank 58 extends past the bottom 44 of the multi-cavity object 32. At step 112, the portion 60 of the shank is threadably received in the receiving hole 62 of the second object 34. At step 114, the head 56 of the fastener 38 is rotated to fasten the multi-cavity object 32 to the second object 34. The steps of method 100 may be performed manually or by automation.

The sleeve 36 may facilitate guiding the fastener 38 through the multi-cavity object 32 to prevent interference of the cavities 48, 50, thereby ensuring engagement with the receiving hole 62. The sleeve 36 may be relatively simple to manufacture and provides an inexpensive, low weight solution to fastening through the multi-cavity object 32. Fastening directly through the multi-cavity object 32 may provide space and packaging advantages, such as in the packaging space of the battery pack 22 for the electrified vehicle 20.

Although the different non-limiting embodiments are illustrates as having specific components or steps, the embodiments of this disclosure are not limited to those particular combinations. It is possible to use some of the components or features from any of the non-limiting embodiments in combination with features or components from any of the other non-limiting embodiments. In other words, placement and orientation of the various components of fastening assembly 30 are shown schematically and could vary within the scope of this disclosure. For example, although the multi-cavity object 32 is illustrated and described with reference to a single divider 42 and two cavities 48, 50, multi-cavity object 32 may have any number of dividers and cavities between the top 40 and bottom 44. Additionally, the contents of this disclosure may be applicable to fastening an object including only a single cavity.

The various figures accompanying this disclosure are not necessarily drawn to scale, and some features may be exaggerated or minimized to emphasize certain details of a particular component. It should be understood that like reference numerals identify corresponding or similar elements through the several drawings. It should also be understood that although a particular component arrangement is disclosed and illustrated in these exemplary embodiments, other arrangements could also benefit from the teachings of this disclosure.

The foregoing description shall be interpreted as illustrative and not in any limiting sense. A worker of ordinary skill in the art would understand that certain modifications could come within the scope of this disclosure. For these reasons, the following claims should be studied to determine the true scope and content of this disclosure.

What is claimed is:

1. An assembly, comprising:
an object including a cavity;
a sleeve received through a hole formed through the object and extending through the cavity; and
a fastener received within the sleeve.

2. The assembly of claim 1, wherein the object includes a divider between a top and a bottom, the cavity is a first cavity positioned between the top and the divider and a second cavity is positioned between the divider and the bottom.

3. The assembly of claim 2, wherein the hole extends through the top, the divider, and the bottom, and the sleeve extends from the top, through the divider and the first and second cavities, to the bottom of the object.

4. The assembly of claim 2, wherein a top of the sleeve is sub-flush with the top of the object.

5. The assembly of claim 2, wherein the fastener includes a head that sits on the top of the object, the head including a diameter that is greater than a diameter of the sleeve and a diameter of the hole.

6. The assembly of claim 5, wherein the fastener includes a shank extending through the sleeve from the top, through the divider and the first and second cavities, and a portion of the shank extends past the bottom of the object.

7. The assembly of claim 6, wherein the object is a first object and further comprising a second object including a receiving hole, wherein the portion of the shank is received in the receiving hole.

8. The assembly of claim 1, wherein the object is a first object and further comprising a second object including a receiving hole, wherein the fastener is partially received in the receiving hole.

9. The assembly of claim 8, wherein the first object is disposed between a first row and a second row of battery cells in a battery enclosure of an electrified vehicle, and the second object is a floor of a tray of the battery enclosure.

10. The assembly of claim 8, wherein the first object is disposed adjacent to a second tier row of battery cells in a battery enclosure of an electrified vehicle, and the second object is a support structure of a first tier row of battery cells.

11. The assembly of claim 1, wherein the sleeve includes a lead-in taper such that there is a larger nominal gap between the sleeve and the hole at a bottom of the sleeve than at a top of the sleeve.

12. A method, comprising:
inserting a sleeve through a hole formed in a first object such that the sleeve extends through a cavity of the object;
aligning the hole of the first object with a receiving hole of a second object;
inserting a fastener into the sleeve to guide the fastener to be partially received in the receiving hole.

13. The method of claim 12, wherein the first object includes a divider between a top and a bottom, the cavity is a first cavity positioned between the top and the divider and a second cavity is positioned between the divider and the bottom.

14. The method of claim 13, further comprising providing the hole through the top, the divider and the bottom prior to the step of inserting the sleeve.

15. The method of claim 13, wherein inserting the sleeve includes inserting the sleeve such that it extends from the top, through the divider and the first and second cavities, to the bottom of the first object.

16. The method of claim 15, wherein the step of inserting the fastener includes inserting a shank of the fastener such that it extends through the sleeve from the top, through the divider and first and second cavities, and a portion of the shank extends past the bottom of the first object and is received in the receiving hole.

17. The method of claim 12, further comprising fastening the first object to the second object by rotating the fastener.

18. The method of claim 12, wherein the first object is disposed between a first row and a second row of batteries in a battery enclosure of an electrified vehicle and the second object is a floor of a tray of the battery enclosure.

19. A traction battery pack, comprising:
a tray including a floor and side walls;
a plurality of battery arrays supported on the tray;
an object positioned adjacent to at least one of the plurality of battery arrays and extending between the side walls, the object including a cavity;
a sleeve received through a hole formed through the object and extending through the cavity; and
a fastener received within the sleeve.

20. The traction battery pack of claim 19, wherein the floor includes a receiving hole and the fastener is partially received in the receiving hole.
